(19) United States
(12) Patent Application Publication
(10) Pub. No.: US 2023/0017434 A1
(43) Pub. Date: Jan. 19, 2023

(54) 3D Printers and Laminates

(71) Applicant: VICI Transition, Inc, Gig Harbor, WA (US)

(72) Inventor: Amos Gottlieb, San Francisco, CA (US)

(21) Appl. No.: 17/787,293

(22) PCT Filed: Dec. 18, 2020
(86) PCT No.: PCT/US20/66252

§ 371 Date: Jun. 21, 2022

Related U.S. Application Data
(60) Provisional application No. 62/950,072, filed on Dec. 18, 2019.

(51) Int. Cl. B32B 27/08; B33Y 30/00; B32B 27/16; B32B 27/30; B32B 27/32; B32B 9/00; B32B 9/04

(52) U.S. Cl. CPC B32B 27/08; B33Y 30/00; B32B 27/16; B32B 27/302; B32B 27/325; B32B 27/322; B32B 9/007; B32B 9/045; B29C 64/124

(57) ABSTRACT

3D printers and novel polymeric laminates for use in 3D printers. The novel laminates comprise a first layer composed of a PMP polymer, a PPO polymer or the like and a second layer composed of an amorphous fluoropolymer.

### FIELD OF THE INVENTION

This invention relates to 3D printers and to polymeric laminates for use in 3D printers.

### BACKGROUND OF THE INVENTION

Several types of 3D printer make use of a film or sheet having desired permeability characteristics. Some types of 3D printer, e.g. CLIP printers (CLIP being an abbreviation for Continuous Liquid Interface Production or Continuous Liquid Interface Printing), DLP printers (3D printers which are based on a digital light projector or digital light processor), DLV printers (3D printers which are based on a digital light valve) and some SLA 3D printers require the use of a film or sheet which is permeable to oxygen. Some other types of 3D printer can benefit from, or require the use of, a film or sheet which can be, but is not necessarily, permeable to oxygen. For a description of some 3D printers, reference may be made to U.S. Pat. No. 9,200,678, 9,211,678, 9,636,873, 9,486,964 and 10,016,938, the entire contents of which are incorporated herein by reference for all purposes, and to https://www.tth.com/carbon-clip. The laminates of the invention are particularly useful in 3D printers, but are also useful in other ways.

### BRIEF DESCRIPTION OF THE DRAWINGS

The invention is illustrated in the accompanying drawings which are diagrammatic and not to scale.

FIG. 1 is an exemplary schematic diagram of a DLP 3D printer.

FIG. 2 is another exemplary schematic diagram of a DLP 3D printer.

FIG. 3 is a diagrammatic cross-sectional view of an exemplary laminate of the invention.

FIG. 4 is a diagrammatic enlarged cross-sectional view of a portion of an exemplary laminate of the invention.

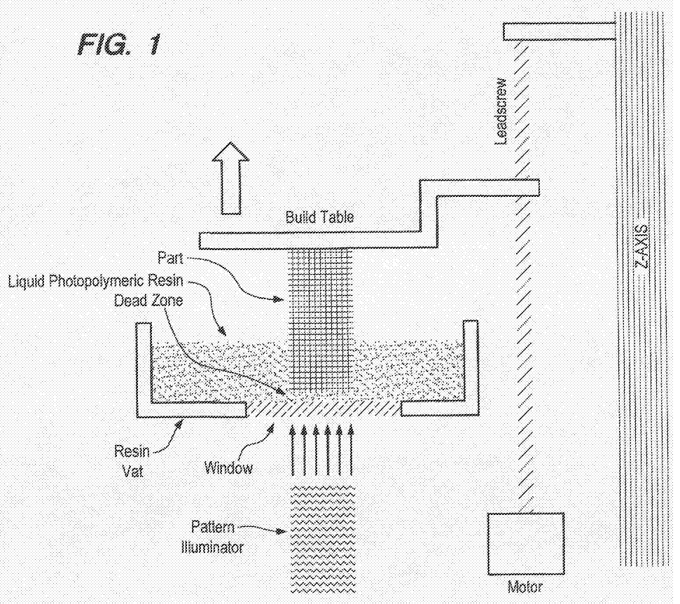

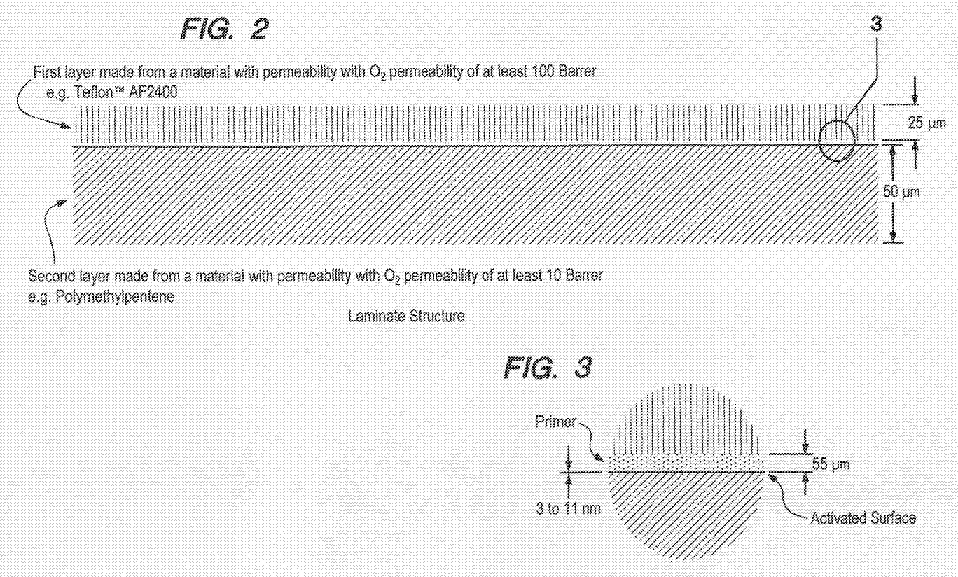

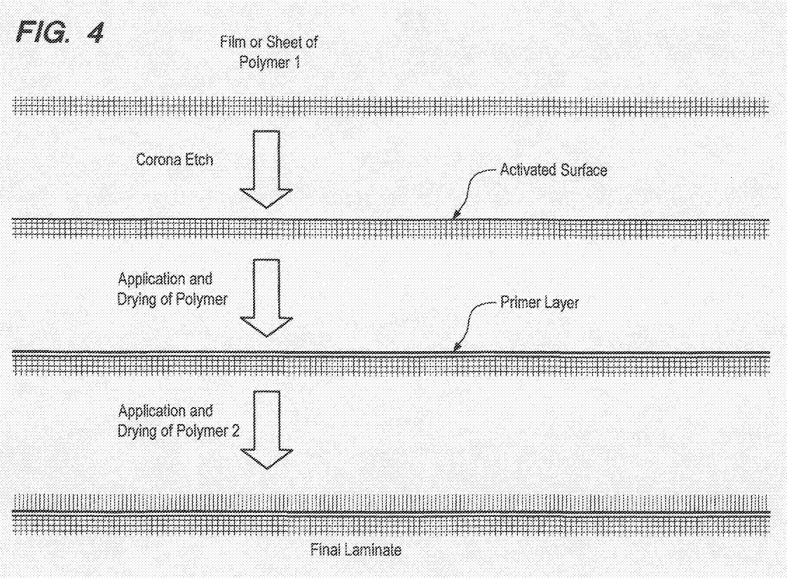

### BRIEF DESCRIPTION OF THE INVENTION

In its first aspect, this invention relates to a laminate which comprises
(1) a first layer which transmits light and is composed of a first polymeric composition, the first polymeric composition being a single polymer or a mixture of polymers, the polymer or at least one of the polymers preferably being a non-elastomeric polymer and preferably having a glass transition temperature of at least 0° C., for example a PMP polymer as hereinafter defined, and
(2) a second layer which transmits light, which adheres to the first layer and which is composed of a second polymeric composition, the second polymeric composition being a single polymer or a mixture of polymers, the polymer or at least one of the polymers being a fluoropolymer as hereinafter defined.
   The first layer (which comprises the first polymeric composition) preferably has an oxygen permeability of at least 10 Barrer. The second layer (which comprises the fluoropolymer) preferably has an oxygen permeability of at least 100 Barrer.

In some embodiments, there is a thin layer of a primer which is between the first and second layers and which promotes adhesion of the two layers to each other. The layer of primer, when it is present, is so thin (for example less than 80 nm) that its oxygen permeability is not significant

In its second aspect, this invention provides methods of making a laminate according to the first aspect of the invention. In one embodiment, the method comprises the steps of
(1) providing a first film which is a preformed film of the first polymeric composition (which may for example be a PMP polymer as hereinafter defined),
(2) subjecting a surface of the first film to an activation step, the activation step comprising, for example, subjecting a surface of the preformed film to a corona discharge or plasma etching treatment, and/or applying a primer to a surface of the preformed film,
(3) providing a layer of a liquid composition comprising the second polymeric composition (which comprises a fluoropolymer as hereinafter defined) on the surface of the preformed film, and
(4) hardening the layer of the liquid composition comprising the second polymeric composition.
   Other methods of making a laminate according to the first aspect of the invention are described below in the Detailed Description of the Invention.

In a third aspect, this invention provides a 3D printer in which, when the 3D printer is in use, a resin is photo polymerized to produce an article and which makes use of a laminate of the first aspect of the invention which is transparent to the wavelength of light used to initiate the photo polymerization of the resin.

In a fourth aspect, this invention provides a method of 3D printing which makes use of a 3D printer according to the third aspect of the invention.

### DETAILED DESCRIPTION OF THE INVENTION

In the Summary of the Invention above, the Detailed Description of the Invention, the Examples, and the claims below, and the accompanying drawings, reference is made to particular features of the invention. These features can for example be components, ingredients, elements, devices, apparatus, systems, groups, ranges, method steps, test results and instructions, including program instructions.

It is to be understood that the disclosure of the invention in this specification includes all possible combinations of such particular features. For example, where a particular feature is disclosed in the context of a particular aspect or embodiment of the invention, or a particular claim, or a particular Figure, that feature can also be used in combination with and/or in the context of other particular aspects, embodiments, claims and Figures, and in the invention generally, except where the context excludes that possibility.

The invention disclosed herein, and the claims, include embodiments not specifically described herein and can for example make use of features which are not specifically described herein, but which provide functions which are the same, equivalent or similar to, features specifically disclosed herein.

The term “comprises” and grammatical equivalents thereof are used herein to mean that, in addition to the features specifically identified, other features are optionally present. For example, a composition or device “comprising” (or “which comprises”) components A, B and C can contain only components A, B and C, or can contain not only components A, B and C but also one or more other components.

The term “consisting essentially of” and grammatical equivalents thereof is used herein to mean that, in addition to the features specifically identified, other features may be present which do not materially alter the claimed invention.

The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%.

The term “at least one of . . . two or more named components” is used herein to denote a single one of the named components or any combination of two or more of the named components.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When a range is given as “(a first number) to (a second number)” or “(a first number)−(a second number)”, this means a range whose lower limit is the first number and whose upper limit is the second number. For example, “from 8 to 20 carbon atoms” or “8-20 carbon atoms” means a range whose lower limit is 8 carbon atoms, and whose upper limit is 20 carbon atoms. The terms “plural”, “multiple”, “plurality” and “multiplicity” are used herein to denote two or more than two features.

Where reference is made herein to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps, except where the context excludes that possibility.

Where reference is made herein to “first” and “second” features, this is generally done for identification purposes; unless the context requires otherwise, the first and second features can be the same or different, and reference to a first feature does not mean that a second feature is necessarily present (though it may be present).

Where reference is made herein to “a” or “an” feature, this includes the possibility that there are two or more such features (except where the context excludes that possibility). Thus, there may be a single such feature or a plurality of such features. Where reference is made herein to two or more features, this includes the possibility that the two or more features are replaced by a lesser number or greater number of features which provide the same function, except where the context excludes that possibility.

The numbers given herein should be construed with the latitude appropriate to their context and expression; for example, each number is subject to variation which depends on the accuracy with which it can be measured by methods conventionally used by those skilled in the art at the date of filing of this specification.

The term “and/or” is used herein to mean the presence of the possibilities stated before and after “and/or”. The possibilities can for example be components, ingredients, elements, devices, apparatus, systems, groups, ranges and steps) is present. For example

(i) “item A and/or item B” discloses three possibilities, namely (1) only item A is present. (2) only item B is present, and (3) both item A and item B are present, and

(ii) “item A and/or item B and/or item C” discloses seven possibilities, namely (1) only item A is present, (2) only item B is present, (3) only item C is present, (4) both item A and item B are present, but item C is not present, (5) both item A and item C are present, but item B is not present, (6) both item B and item C are present, but item A is not present, and (7) all of item A, item B and item C are present.

Where this specification refers to a component “selected from the group consisting of . . . two or more specified sub-components”, the selected component can be a single one of the specified sub-components or a mixture of two or more of the specified sub-components.

If any element in a claim of this specification is considered to be, under the provisions of 35 USC 112, an element in a claim for a combination which is expressed as a means or step for performing a specified function without the recital in the claim of structure, material, or acts in support thereof, and is, therefore, construed to cover the corresponding structure, material, or acts described in the specification and equivalents thereof, then the corresponding structure, material, or acts in question include not only the corresponding structure, material, or acts explicitly described in the specification and the equivalents of such structure, material, or acts, but also such structure, material, or acts described in the US patent documents incorporated by reference herein and the equivalents of such structure, material, or acts. Similarly, if any element (although not specifically using the term “means”) in a claim of this application is correctly construed as equivalent to the term means or step for performing a specified function without the recital in the claim of structure, material, or acts in support thereof, then the corresponding structure, material, or acts in question include not only the corresponding structure, material, or acts explicitly described in the specification and the equivalents of such structure, material, or acts, but also such structure, material, or acts described in the US patent documents incorporated by reference herein and the equivalents of such structure, material, or acts.

This specification incorporates by reference all documents referred to herein and all documents filed concurrently with this specification or filed previously in connection with this application, including but not limited to such documents which are open to public inspection with this specification.

The term “fluoropolymer” is used herein to denote an amorphous polymer comprising units derived from a monomer containing at least one fluorinated carbon atom, preferably at least one perfluorinated carbon atom, for example one or more of (i) a monomer which is a perfluorinated ethylenically unsaturated hydrocarbon, for example tetrafluoroethylene, and/or (ii) perfluoro methyl vinyl ether, and/or (iii) a monomer containing a perfluoro-1,3-dioxole moiety. The fluoropolymer can be a homopolymer, or a copolymer (including a terpolymer). Examples of the monomers that can be used are (i) perfluoro-2,2-dimethyl-1,3-dioxole (ii) perfluoro-1,3-dioxole, (iii) perfluoro-1,3-dioxolane, (iv) perfluoro-2,2-bis-methyl-1,3-dioxole, (v) 2,2,4-trifluoromethyl-5-trifluoromethoxy-1,3-dioxole, (vi) perfluoro-2-methylene-4-methyl-1,3-dioxolane, (vii) a perfluoro-2,2-dialkyl-1,3-dioxole, (viii) 2,2-bis (trifluoromethyl)-4,5-difluoro-1,3-dioxole, and (ix) 2,2-bis (trifluoromethyl)-4-fluoro-5-trifluoromethoxy-1,3-dioxole. The fluoropolymer preferably contains at least 80 mol percent, for example about 100 mol percent, of units derived from one or more monomers each of which contains at least one fluorinated, preferably perfluorinated, carbon atom. These and other perfluoropolymers are disclosed in U.S. Pat. Nos. 4,399,264, 4,935,477, 5,286,283, 5,498,682 and 5,008,508, the entire contents of which are incorporated herein by reference for all purposes.

Examples of commercially available perfluoropolymers include the products sold under the tradenames Teflon AF 1100, Teflon AF 1300, Teflon AF 2400, Teflon AF 1600 and Hyflon AD.

The term “PMP polymer” is used herein to denote a polymer containing units derived from 4-methyl-1-pentene. The PMP polymer preferably comprises at least 80 mol percent, for example about 100 mol percent, of repeating units derived from 4-methyl-1-pentene. The PMP polymer can be a copolymer of 4-methyl-1-pentene and a monomer containing functional units, for example functional units which improve the adhesion between the first and second layers of the laminate or, when the laminate includes a primer, to the primer. Such copolymers are, for example, disclosed in U.S. Pat. No. 7,524,913 (publication No. 2008 0021172), the entire disclosure of which is incorporated herein by reference for all purposes.

Examples of commercially available PMP polymers include those sold under the tradenames MX 004, MX 0020, MX 002, R-18 and DX 485.

The term “PPO polymer” is used herein to denote a polymer derived from one or more substituted phenylene oxides (including mixtures thereof), in which the phenyl group is substituted by 1, 2 or 3 alkyl, substituted alkyl, phenyl, substituted phenyl, halogen, alkoxy, alkenyl, alkynyl or amino groups, for example poly (2,6-dimethyl-p-phenylene oxide) and related polymers in which one or both of the methyl groups is replaced by a different group, for example the polymer in which each of the methyl groups is replaced by a phenyl group.

The term “carbon molecular sieve membrane” is used herein to denote the CMSM materials described by Xiao-Hau, Gas Separation Membranes, Adv Poly. Materials, 2018),

### The First Layer of the Laminate.

The first layer of the laminate is composed of a first polymeric composition, the first polymeric composition being a single polymer or a mixture of polymers, the polymer or at least one of the polymers preferably being a non-elastomeric polymer and preferably having a glass transition temperature of at least 0° C. In one embodiment, the first polymeric composition comprises a PMP polymer as hereinbefore defined. In this embodiment, the first composition can consist essentially of a homopolymer or copolymer of 4-methyl-1-pentene. In other embodiments, the first layer is composed of a different polymeric composition, for example a polyester such as Mylar, poly (2,6-diphenyl-p-phenylene oxide), CMSMs as described by Xiao-Hau, Gas Separation Membranes, Adv Poly. Materials, 2018, a polyacetylene, a para-substituted polystyrene, or a polynorbornene, for example poly (trimethylsilylnorbornene).

The thickness of the first layer can for example be 0.25-5 mil, e.g. 0.75-2 mil. The oxygen permeability of the first layer is preferably at least 10 Barrer.

### The Second Layer of the Laminate.

The second layer of the laminate is composed of a second polymeric composition, the second polymeric composition being a single polymer or a mixture of polymers, the polymer or at least one of the polymers being a fluoropolymer as hereinbefore defined.

The thickness of the second layer is preferably 0.5-500 μm, for example 1-100 μm, e.g. 5-25 μm.

### The Layer of Primer.

The laminate optionally comprises a layer of a primer between the first and second layers. As noted above, a preferred process for preparing the laminate includes the creation of a layer of primer on the surface of the preformed film of the first polymeric composition. The layer of the primer need not be continuous, but can for example be a series of lines, a pattern of rectangles or a series of drops in a regular or irregular pattern.

The primer is preferably a compound comprising functional groups which can interact with one or both of the first and second layers. Thus, the primer can include a fluorinated portion which promotes adhesion to the layer containing a fluoropolymer and/or another portion which adheres to the other layer of the laminate. The primer compound can for example be a fluoropolymer as defined which contains one or more functional groups, for example a carboxylic group. The presence in the primer of one or more perfluorinated carbon atoms assists adhesion to the second (fluoropolymer) layer, and the presence of suitable functional groups, for example terminal and/or pendant carboxyl groups or phosphate groups, assists adhesion to the first layer, which may for example comprise a PMP polymer. Suitable primers include dicarboxy-(polyperfluoro-2,3-dimethylene-1-oxolane), a copolymer of perfluoroethylene and perfluoro-2,2-bis-methyl-1,3-dioxole with terminal and/or pendent carboxylic acid groups or phosphate groups, Fluorolink AD1700, Fluorolink phosphate, Fluorolink MD 700 and amide-terminated Fluorolink. Other solvents can be used including the Galden fluids from Solvay (e.g. Galden HT135) and Flutec from Rhone-Poulenc (e.g. Flutec PP6.)

The primer can be applied to the preformed film of the first polymeric composition (which is for example a PMP polymer) as a solution in a solvent which is later wholly or almost completely removed, thus creating a thin layer of the primer compound on the surface of the first film. The amount of the solvent remaining in the layer of primer is preferably less than 5%, particularly less than 2%, by weight of the layer of primer. The primer can be applied as a solution in a fluorinated solvent, e.g. Fluorinert or Novack, the solution containing for example 0.5-5% by weight of the primer. The solution of the primer can be applied in any way, for example by means of an ultrasonic spray nozzle, or manual wiping. The thickness of the dried layer can for example be from about 10 nm to about 5 μm

### Transparency of the Laminate.

Many 3D printers rely upon the photopolymerization of a resin when the resin is exposed to light of a particular wavelength. The wavelengths in current use are about 385 nm, about 405 nm and about 420 nm, but probably other wavelengths will be employed in the future. The laminate should be sufficiently, preferably essentially, transparent to the wavelength used to photopolymerize the resin.

### Methods of Making the Laminates.

One preferred method of making a laminate according to the first aspect of the invention has been described above. That method preferably employs both activation of the preformed film composed of the first polymeric composition (for example containing the PMP polymer) and application of the primer solution to the activated surface of the preformed film. The activation can for example comprise exposing the surface of the film to corona etching and/or plasma etching. The application of the primer solution should be carried out while the effect of the activation is still present. A solution of the second polymeric composition (comprising the fluoropolymer) is then coated on the surface of the preformed film, and heated to remove most of the solvent and produce a hard layer of the second composition comprising the fluoropolymer.

In other embodiments, the laminate according to the first aspect of the invention is prepared by the steps of (A) providing a preformed film comprising the first or the second polymeric composition; (B) activating a surface of the preformed film and/or applying a primer composition to a surface of the preformed film; and (C) providing a film comprising the first or the second polymeric composition, the composition being different from the polymeric composition in the preformed film in step (A), on the surface of the preformed film. The term “providing a film;” in step (C) includes two possibilities, namely (i)) applying a preformed film of a polymeric composition, the composition being different from the polymeric composition in the preformed film in step (A) to the surface of the preformed film used in step (B), or (ii) applying a liquid comprising the polymeric composition to the film resulting from step (A), and (iii) solidifying the liquid composition resulting from step (C iii).

In another embodiment, the laminate is prepared by a process which comprises the steps of

(A) mounting a roll of a preformed film composed of one or other of the first and second polymeric compositions, for example the first polymeric composition optionally containing a PMP polymer, in a web coating machine;

(B) subjecting one surface of the preformed film to an activation step and/or coating one surface of the preformed film with a solution of a primer which is subsequently dried;

(C) applying to the surface of the preformed film from step (B) a solution comprising either the first or second polymeric composition, the composition being different from the polymeric composition in the preformed film, for example the second polymeric composition comprising a fluoropolymer, and drying the solution

(D) repeating step (C) at successive coating stations until the desired thickness of the dried polymeric composition has been achieved.

In another embodiment, the laminate is prepared using an extrusion line capable of co-extruding two or more polymeric compositions. There is a separate hopper and extrusion barrel for each of the first and second polymeric compositions. Each of the first and second polymeric compositions is loaded into its hopper and the laminate is extruded with one layer consisting of the first polymeric composition and a second layer consisting of the second polymeric composition.

### Example 1

A 1 mil film of poly (4-methyl-1pentene) [available from Air-Tech, Huntington California] was given a corona etch treatment [using a Model BD-20 available from Electro-Tech, Chicago, Ill.] and then spray coated, using an ultrasonic sprayer [available from Sono-Tech, Milton, New York] with a thin layer of a primer in the form of a 1% solution of dicarboxy-(polyperfluoro-2,3-dimethylene-1-oxolane) in Fluorinert FC-40. The oxolane solution was evenly spread over the entire surface of the PMP film and allowed to dry, initially at room temperature and then at 150° C. for 15 minutes. The primed surface of the PMP film was coated with a solution of Teflon AF 2400 in Fluorinert FC-40. The resulting product was initially cured at 80° C. with a final cure in vacuo at an elevated temperature. The layers in the resulting film could not be separated by hand. The oxygen permeability of the dried layer of oxolane primer was less than or equal to 10 Barrer.

### Example 1

A 50 μm thick film of PMP (Mitsui Chemical) was treated with a Model BD-20 corona etcher (Electro-Tech, Chicago, Ill.). A 1% solution of dicarboxy-(polyperfluoro-2,3-dimethylene-1-oxolane) in Fluorinert FC-40 was applied at room temperature with an ultrasonic sprayer (Sono-tek, Milton, N.Y.) at a power level of 2.3 and a flow rate of 1.0 ml/min. The primer coated PMP film was initially air-dried followed by a high temperature drying at 150° C. for 15 minutes. The primed PMP film was coated with a 4.41% solution of Teflon AF2400 and initially dried at 80° C. Subsequent drying occurred at 180° C. temperature and a vacuum of 0.060 mm Hg. The layers in the resulting film could not be separated by hand. Using a non-contact thin film measurement device (Filmetrics, Sunnyvale, Calif.) the thickness of the laminate was measured and showed that the Teflon AF2400 layer had a thickness of 25 μm and that the thickness of the PMP layer was 50 μm

### Example 2

A 50 μm thick film of PMP] Mitsui Chemical] was treated with a Model BD-20 corona etcher J Electro-Tech, Chicago, Ill. A 1% solution of dicarboxy-(polyperfluoro-2,3-dimethylene-1-oxolane) in Fluorinert FC-40 was applied at room temperature with an ultrasonic sprayer [Sono-tek, Milton, New York] at a power level of 2.3 and a flow rate of 1.0 ml/min. The primer-coated PMP film was initially air-dried followed by a high temperature drying at 150° C. for 15 minutes. The primed PMP film was coated with a 4.41% solution of Teflon AF2400 and dried initially at 80 and then occurred at 180° C. under a vacuum of 0.060 mm Hg. The layers in the resulting film could not be separated by hand. Using a non-contact thin film measurement device [Filmetrics, Sunnyvale, Calif.], the thickness of the laminate was measured and showed that the Teflon AF2400 layer had a thickness of 25 μm and the PMP layer had a thickness 50 μm.

### Example 3

A 2 mil film of PMP [MX 002, Honeywell] is corona etched and then spray coated with a thin layer of a primer which is a copolymer of perfluoroethylene and perfluoro-2,2-bis-methyl-1,3-dioxole with terminal carboxylic acid groups [Chemours, Wilmington, Del.]. This primer has an oxygen permeability greater than 10 Barrer and is typically greater than 50 Barrer. The spray-coated layer is dried and the film is then coated with a 6% solution of Teflon AF 1600 in FC-40. The product is cured, initially at 80° C. and then in vacuo at the glass transition temperature of the Teflon AF 1600. This is an example of using a primer with oxygen permeability greater than or equal to 10 Barrer.

### Example 4

A 2.5 mil film of DX 485 PMP [Specialty Extruders, Royersford, Pennsylvania] is corona etched and then spray coated with a thin layer of 1% solution of a copolymer of perfluoroethylene and perfluoro-2,2-bis-methyl-1,3-dioxole with terminal phosphate groups. The spray-coated layer is dried and the spray-coated film is coated with a 4.4% solution of Teflon AF 2400 in FC-43. The product is cured, initially at 80° C. and then in vacuo at an elevated temperature.

### Example 5

A 5 mil film of DX 485 PMP [Westlake Plastics, Lenni, Pennsylvania] is corona etched and then spray coated with a thin layer of 1% solution of SF60 [Chemours, Wilmington, Del.]. The spray-coated layer is dried and the spray-coated film is coated with a 4.4% solution of Teflon AF 2400 in FC-40. The product is cured, initially at 80° C. and then in vacuo at 100° C.

### Example 6

A 2 mil film of DX 485 PMP [Specialty Extruders, Royersford, Pennsylvania] is plasma etched and then spray coated with a 1% solution EVE-P [Chemours, Wilmington, Del.]. The spray-coated layer is dried and the spray-coated film is coated with a 4.4% solution of Teflon AF 2400 in FC-43. The product is cured, initially at 80° C., and then in vacuo at 180° C.

### Example 7

A B9 Core 550 3D printer [89 Creations, Rapid City S. Dak.] is used to produce 3D print of the standard 89 Creations test piece. The conventional Teflon AF 2400 window is removed and replaced by a window prepared as in Example 2. The vat is filled with resin and a sample of the standard test piece is run at the same speed.

### Example 7

A laminate prepared as described in Example 2 was mounted in the tray of a different 3D printer. A number of 3D prints were made and it was observed that there was no apparent difference in the 3D prints made with a monolithic Teflon AF 2400 film and those made with the laminate prepared according to Example 2. The printer speed, resolution, and pull forces were the same when a monolithic Teflon AF 2400 film was used and when the laminate prepared according to Example 2 was used.

Additional Information about the Invention Follows.

This invention addresses the need, in some 3D printers, for light transmissive, oxygen-permeable, materials to be used in the tray or build area (also referred to as the build plate or build assembly) of several types of 3D printers. It also addresses the desire, in some 3D printers, for light transmissive materials to be used in the tray or build area of a 3D printer that benefits from non-stick properties and may or may not be permeable to oxygen. The preferred laminate of this invention comprises at least two layers in which one layer consists of an amorphous fluoropolymer and the second layer consists of a material which is a non-elastomeric material having a glass transition temperature equal to or higher than 0° C. Examples of the types of 3D printers that can have their performance increased by the use of these materials include, but are not limited to, DLP (3D printers based on a digital light projector or digital light processor), DLV (3D printers based on a digital light valve), CLIP 3D printers, SLA 3D printers and other 3D printers.

Some 3D printers operate on the basis of a light source that launches light through a transparent build area (also known as the build plate or build assembly), usually a transparent area of the tray that holds the resin that will form the part, and said light triggers a chemical polymerization in the resin according to the pattern of the light that is launched. Typically, there is a moving stage (a carrier) that moves vertically away from the build area as the part is being generated. If the transparent build area has a non-stick surface such as a perfluoropolymer, the part will have greatly reduced adhesion to the build area. In addition, if the transparent build area is oxygen permeable then, with some resins, the polymerization will be quenched in a narrow region between the part that is being built and the build area. In this case the part being built and the build area never come in contact and there is no adhesion between the 3D part and the build area. For example, see U.S. Pat. Nos. 9,636,873, 10,016,938 and 9,211,678, the entire contents of each of which is incorporated by reference herein for all purposes. As described in U.S. Pat. No. 9,636,873, the method is:
“A method of forming a three-dimensional object, is carried out by (a) providing a carrier and a build plate, the build plate comprising a semipermeable member, the semipermeable member comprising a build surface with the build surface and the carrier defining a build region there between, and with the build surface in fluid communication by way of the semipermeable member with a source of polymerization inhibitor, (b) filling the build region with a polymerizable liquid, the polymerizable liquid contacting the build surface, (c) irradiating the build region through the build plate to produce a solid polymerized region in the build region, while forming or maintaining a liquid film release layer comprised of the polymerizable liquid formed between the solid polymerized region and the build surface, wherein the polymerization of which liquid film is inhibited by the polymerization inhibitor; and (d) advancing the carrier with the polymerized region adhered thereto away from the build surface on the build plate to create a subsequent build region between the polymerized region and the build surface while concurrently filling the subsequent build region with polymerizable liquid as in step (b).
   The following STATEMENTS provide additional details of the invention.
   Statement 1A. Apparatus for preparing an article having a desired configuration, the configuration comprising different parts which are on top of or otherwise adjacent to each other, the apparatus comprising
(1) a photo-polymerizable polymeric composition,
(2) a window, preferably a planar window, having an upper surface and an opposite lower surface,
(3) means for delivering the polymeric composition onto or adjacent to the upper surface of the window,
(4) means for projecting a pattern of light onto the lower surface of the window, the pattern corresponding to a part of the desired configuration, and the window being transparent to the light,
   whereby, when the apparatus is in operation, the polymeric composition is photopolymerized on or adjacent to the upper surface of the window, and forms a part corresponding to a part of the desired configuration;

characterized in that the window is an oxygen-permeable laminate comprising a first layer and a second layer,

the first layer being composed of a first polymeric composition comprising a PMP polymer as hereinbefore defined, and/or a PPO polymer as hereinbefore defined, and/or a carbon molecular sieve membrane as hereinbefore defined, and/or a polyacetylene, and/or a para-substituted polystyrene, and/or a polynorbonene, and

the second layer being composed of an amorphous fluoropolymer as hereinbefore defined.

Statement 1B. Apparatus according to Statement 1A wherein at least 80% by weight, preferably substantially 100% by weight, of the first layer is composed of a first polymer which comprises at least 80 mol % of repeating units derived from 4-methyl-1-pentene.
Statement 1C. Apparatus according to Statement 1B wherein the first polymer contains substantially 100 mol % of units derived from 4-methyl-1-pentene.
Statement 1D. Apparatus according to any one of Statements 1A-1C wherein the second layer of the laminate is composed of a second polymeric composition which comprises an amorphous fluoropolymer comprising units derived from a monomer containing at least one perfluorinated carbon atom.
Statement 1E. Apparatus according to Statement 1D wherein the monomer comprises a perfluorinated ethylenically unsaturated hydrocarbon.
Statement 1F. Apparatus according to Statement 1E wherein the monomer is (i) tetrafluoroethylene, and/or (ii) perfluoro methyl vinyl ether, and/or (iii) a monomer containing a perfluoro-1,3-dioxole moiety.
Statement 1G. Apparatus according to Statement 1E wherein the monomer comprises (i) perfluoro-2,2-dimethyl-1,3-dioxole, and/or (ii) perfluoro-1,3-dioxole, and/or (iii) perfluoro-1,3-dioxolane, and/or (iv) perfluoro-2,2-bis-methyl-1,3-dioxole, and/or (v) 2,2,4-trifluoromethyl-5-trifluoromethoxy-1,3-dioxole, and/or (vi) perfluoro-2-methylene-4-methyl-1,3-dioxolane, and/or (vii) a perfluoro-2,2-dialkyl-1,3-dioxole, and/or (viii) 2,2-bis (trifluoromethyl)-4,5-difluoro-1,3-dioxole, and/or (ix) 2,2-bis (trifluoromethyl)-4-fluoro-5-trifluoromethoxy-1,3-dioxole. The fluoropolymer preferably contains at least 80 mol percent, for example about 100 mol percent, of units derived from one or more monomers each of which contains at least one fluorinated, preferably perfluorinated carbon atom.
Statement 1H. Apparatus according to any of Statements 1A-1G which comprises a primer between the first and second layers.
Statement 1I. Apparatus according to any of Statements 1A-1H wherein the dimensions of the laminate remain unchanged and the layers of the laminate remain secured to each other throughout the operation of the apparatus.
Statement 1J. Apparatus according to any of Statements 1A-1H wherein the layers of the laminate cannot be separated manually.
Statement 1K. Apparatus according to any of Statements 1A-1J wherein the thickness of the first layer is 0.25-5 mil, e.g. 0.75-2 mil.
Statement 1L. Apparatus according to any of Statements 1A-1K wherein the thickness of the second layer is 0.5-500 μm, for example 1-100 μm, e.g. 5-25 μm.
Statement 1M Apparatus according to any of the preceding Statements wherein the oxygen permeability of the first layer is at least 10 Barrer.
Statement 1N. Apparatus according to any of the preceding Statements wherein the oxygen permeability of the second layer is at least 100 Barrer.
Statement 10. Apparatus according to any of the preceding Statements wherein the wavelength of the light is 370-450 nm, e.g. about 385 nm, about 405 nm or about 420 nm.
Statement 2A. Apparatus for preparing an article having a desired configuration, the configuration comprising different parts which are on top of or otherwise adjacent to each other, the apparatus comprising
(1) a photo-polymerizable polymeric composition,
(2) a window, preferably a planar window, having an upper surface and an opposite lower surface,
(3) means for delivering the polymeric composition onto or adjacent to the upper surface of the window, all or
(4) means for projecting a pattern of light onto the lower surface of the window, the pattern corresponding to a part of the desired configuration, and the window being transparent to the light,
   whereby, when the apparatus is in operation, the polymeric composition is photopolymerized on or adjacent to the upper surface of the window, and forms a part corresponding to a part of the desired configuration;
   characterized in that the window is an oxygen-permeable laminate comprising a first layer and a second layer, the first layer being composed of a first polymeric composition, the first polymeric composition being a single polymer or a mixture of polymers, the polymer or at least one of the polymers being a non-elastomeric polymer and having a glass transition temperature of at least 0° C.
   Statement 28. Apparatus according to Statement 2A wherein the laminate is as defined in any of Statements 1A-1N.
   Statement 3A. A laminate comprising a first layer and a second layer, the first layer being composed of a first polymeric composition comprising a PMP polymer as hereinbefore defined and/or a PPO polymer as hereinbefore defined, and/or a carbon molecular sieve membrane as hereinbefore defined, and/or a polyacetylene, and/or a para-substituted polystyrene, and/or a polynorbonene.
   Statement 38. A laminate according to Statement 3A wherein the laminate is as defined in any of Statements 1A-1N.

1. Apparatus for preparing an article having a desired configuration, the configuration comprising different parts which are on top of or otherwise adjacent to each other, the apparatus comprising
(1) a photo-polymerizable polymeric composition,
(2) a window, preferably a planar window, having an upper surface and an opposite lower surface,
to (3) means for delivering the polymeric composition onto or adjacent to the upper surface of the window,
(4) means for projecting a pattern of light onto the lower surface of the window, the pattern corresponding to a part of the desired configuration, and the window being transparent to the light,
whereby, when the apparatus is in operation, the polymeric composition is photopolymerized on or adjacent to the upper surface of the window, and forms a part corresponding to a part of the desired configuration;
characterized in that the window is an oxygen-permeable laminate comprising a first layer and a second layer,
the first layer being composed of a first polymeric composition comprising a PMP polymer as hereinbefore defined, and/or a PPO polymer as hereinbefore defined, and/or a carbon molecular sieve membrane as hereinbefore defined, and/or a polyacetylene, and/or a para-substituted polystyrene, and/or a polynorbonene, and
the second layer being composed of an amorphous fluoropolymer as hereinbefore defined.

2. Apparatus according to claim 1 wherein at least 80% by weight of the first layer is composed of a first polymer which comprises at least 80 mol % of repeating units derived from 4-methyl-1-pentene.

3. Apparatus according to claim 1 wherein the second layer of the laminate is composed of a second polymeric composition which comprises an amorphous fluoropolymer comprising units derived from a monomer containing at least one perfluorinated carbon atom.

4. Apparatus according to claim 1 which comprises a primer between the first and second layers.

5. Apparatus according to claim 1 wherein the thickness of the first layer is 0.25-5 mil in the thickness of the second layer is 0.5-500 μm.

6. Apparatus according to claim 1 wherein the oxygen permeability of the first layer is at least 10 Barrer and the oxygen permeability of the second layer is at least 100 Barrer.

7. Apparatus according to claim 1 wherein the wavelength of the light is 370-450 nm.

8. Apparatus for preparing an article having a desired configuration, the configuration comprising different parts which are on top of or otherwise adjacent to each other, the apparatus comprising
(1) a photo-polymerizable polymeric composition,
(2) a window, preferably a planar window, having an upper surface and an opposite lower surface,
(3) means for delivering the polymeric composition onto or adjacent to the upper surface of the window, all or
(4) means for projecting a pattern of light onto the lower surface of the window, the pattern corresponding to a part of the desired configuration, and the window being transparent to the light,
whereby, when the apparatus is in operation, the polymeric composition is photopolymerized on or adjacent to the upper surface of the window, and forms a part corresponding to a part of the desired configuration;
characterized in that the window is an oxygen-permeable laminate comprising a first layer and a second layer, the first layer being composed of a first polymeric composition, the first polymeric composition being a single polymer or a mixture of polymers, the polymer or at least one of the polymers being a non-elastomeric polymer and having a glass transition temperature of at least 0° C.

9. A laminate comprising a first layer and a second layer, the first layer being composed of a first polymeric composition selected from the group consisting of a PMP polymer as hereinbefore defined, a PPO polymer as hereinbefore defined, a carbon molecular sieve membrane as hereinbefore defined, a polyacetylene, a para-substituted polystyrene, and a polynorbonene.

10. A laminate according to claim 9 wherein at least 80% by weight of the first layer is composed of a first polymer which comprises at least 80 mol % of repeating units derived from 4-methyl-1-pentene.

11. A laminate according to claim 9 wherein the second layer of the laminate is composed of a second polymeric composition which comprises an amorphous fluoropolymer comprising units derived from a monomer containing at least one perfluorinated carbon atom.

12. A laminate according to claim 9 which comprises a primer between the first and second layers.

13. A laminate according to claim 9 wherein the thickness of the first layer is 0.25-15 mil and the thickness of the second layer is 0.5-500 μm.

14. A laminate according to claim 9 wherein the oxygen permeability of the first layer is at least 10 Barrer and the oxygen permeability of the second layer is at least 100 Barrer.
